(19) United States
(12) Patent Application Publication
(10) Pub. No.: US 2016/0197809 A1
(43) Pub. Date: Jul. 7, 2016

(54) SERVER DOWNTIME METERING

(71) Applicant: HEWLETT PACKARD ENTERPRISE DEVELOPMENT LP, Houston, TX (US)

(72) Inventors: Erik Levon Young, Houston, TX (US); Andrew Brown, Houston, TX (US)

(21) Appl. No.: 14/916,295

(22) PCT Filed: Sep. 30, 2013
(86) PCT No.: PCT/US2013/062675

§ 371 Date: Mar. 3, 2016

(51) Int. Cl. H04L 12/26; H04L 12/24

(52) U.S. Cl. CPC H04L 43/0817; H04L 41/5016

(57) ABSTRACT

An example method may include receiving a plurality of control variable signals indicative of at least an operating state of health of a processor of a device and an operating state of an operating system component of the device, the operating state of health of the processor being one of a good state, a degraded state or a critical state, the operating state of the operating system component being one of under control of an operating system driver, under control of a pre-boot component, or a critically failed state; determining an overall state of the device based on the received plurality of control variable signals, the overall state being one of an up state, a degraded state, a scheduled down state and an unscheduled down state; and tracking an amount of time spent in at least the up state, the scheduled down state and the unscheduled down state.

### BACKGROUND

Server uptime is a metric that has been used for years. The metric may be used to determine the performance of a server through calculation of downtime. For example, a server may be determined to have a downtime that is above an acceptable threshold, indicating the need to replace the server with an improved server with a lower downtime.

### BRIEF DESCRIPTION OF THE DRAWINGS

For a more complete understanding of various examples, reference is now made to the following description taken in connection with the accompanying drawings in which:

FIG. 1 illustrates an example server device that may utilize a board management controller downtime meter;

FIG. 2 illustrates an example timeline showing state transitions of an example board management controller downtime meter;

FIG. 3 illustrates an example component tracker that can be used in an example board management controller downtime meter;

FIG. 4A is a flowchart of an example runtime process performed by an example board management controller downtime meter;

FIG. 4B is a flowchart of an example high-level process performed by an example board management controller downtime meter when the runtime process of FIG. 4A is interrupted by a power down or reset event;

FIG. 5 illustrates an example server tracker component diagram showing various control variables monitored by an example board management controller downtime meter to assess a state of a server;

FIG. 6 illustrates various server hardware and software components monitored by an example server tracker component to assess a state of a server;

FIG. 7 illustrates an example startup state diagram showing possible state transitions at startup of an example board management controller downtime meter;

FIG. 8 illustrates an example runtime state diagram showing possible state transitions experienced during runtime for an example board management controller downtime meter;

FIG. 9 illustrates an example activity diagram showing activities performed by an example board management controller downtime meter during a power off or reset event; and

FIG. 10 illustrates an example activity diagram showing activities performed by an example board management controller downtime meter during a power on event.

### DETAILED DESCRIPTION

Server uptime is a metric that has been used for years. Yet, in many situations, it is fundamentally flawed as a performance metric because it makes an assumption that all downtime is bad. In contrast, some downtime can be elected by a user to improve power use, to upgrade outdated equipment, or for other reasons.

Many users of servers are expected to achieve and report on reliability requirements by calculating an availability metric. The typical availability metric is calculated using the following equation, where A is the availability metric, tᵤₚ is uptime and Tₜₒₜₐₗ is the total time:

$$A = \frac{{t}_{up}}{{T}_{total}} \qquad ( 1 )$$

Unfortunately, there are shortcomings in using this availability formula in some computing environments. In order to remain competitive as a hardware supplier and service provider, one should be able to satisfy availability requirements in a meaningful way in order to give a customer an ability to accurately determine a true server availability that is not affected by other hardware and/or software. As one example of a situation that cannot be monitored accurately using formula (1) above, a customer using VMware's VMotion® tool may migrate virtual machines between servers for things like planned maintenance or to save power (because of a lack of demand, for example). With conventional uptime calculations using formula (1), the downtime clock starts the moment the server is powered off. In reality though, the planned maintenance should not be considered as actual downtime because availability has not been lost.

Various examples described herein utilize a management controller to continually monitor server hardware state information including, but not limited to, state duration, state frequency and state transitions over time. The data derived from the state monitoring are used to determine an estimated server downtime where the downtime can take into account those downtime periods that were caused by failure of server hardware and software and disregard those downtime periods attributable to user elected downtimes (e.g., maintenance, upgrades, power savings, etc.), as well as times where the server is available, but in a functional, but degraded, capability. By subtracting downtime attributable to server failure from the total monitoring time, the management controller may be able to measure a server's ability to meet requirements such as, for example, the so called five nines (99.999%) availability goal. In order to determine the described server-attributable downtime and related availability metrics, the management controller may utilize a downtime meter as described herein.

The downtime meter can be used to determine downtime that is attributable to server failure, both hardware and software failures, referred to herein as unscheduled downtime, as well as scheduled downtime attributable to user selected downtime to perform maintenance or save power, for example. In one example, the downtime meter can determine uptime to be not just a reflection of how long a server hosting customer applications is powered on, but also how long the customer applications are actually available. When a server outage occurs, the downtime meter can determine what caused the outage and how long the outage lasted, even when no AC power is available, in some embodiments. The scheduled and unscheduled downtimes can be used by the downtime meter to determine meaningful server availability metrics for servers. The scheduled downtime data, unscheduled downtime data, and availability metrics can be aggregated across a group or cluster of servers, e.g., an increased sample size, in order to improve confidence in the calculations.

From a technological perspective, being able to monitor, quantify and identify failures that cause outages related to a server being able to execute user applications can be used in conjunction with supply feedback to the server/application developer and allow the server/application developer to take corrective action and make improvements with future server hardware and/or application software.

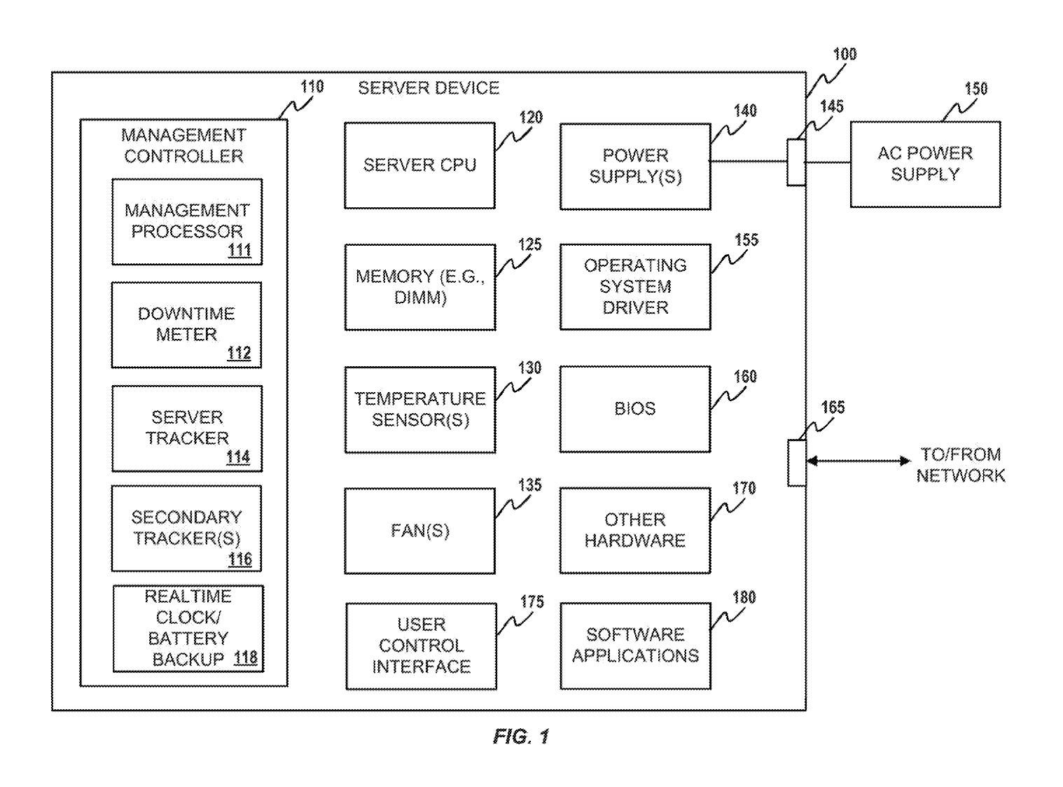

Referring now to FIG. 1, an example server device 100 is illustrated. The example server device 100 of FIG. 1 may be a standalone server such as a blade server, a storage server or a switch, for example. The example server device 100 may include a management controller 110, a server CPU (central processing unit) 120, at least one memory device 125 and a power supply 140. The power supply 140 is coupled to an electrical interface 145 that is coupled to an external power supply such as an AC power supply 150. The server device 100 may also include an operating system component including, for example, an operating system driver component 155 and a pre-boot BIOS (Basic Input/Output System) component 160 stored in ROM (read only memory), referred to herein as a ROM BIOS component 160, and coupled to the CPU 120. In various examples, the CPU 120 may have a non-transitory memory device 125. In various examples, the memory device 125 may be integrally formed with the CPU 120 or may be an external memory device. The memory device 125 may include program code that may be executed by the CPU 120. For example, one or more processes may be performed to execute a user control interface 175 and/or software applications 180.

In various examples, the ROM BIOS component 160 provides a pre-boot environment. The pre-boot environment allows applications, e.g., the software applications 180, and drivers, e.g., the operating system driver component 155. to be executed as part of a system bootstrap sequence, which may include the automatic loading of a pre-defined set of modules (e.g., drivers and applications). As an alternative to automatic loading, the bootstrap sequence, or a portion thereof, could be triggered by user intervention (e.g. by pressing a key on a keyboard) before the operating system driver 155 boots. The list of modules to be loaded may, in various examples, be hard-coded into system ROM.

The example server device 100, after initial boot, will be controlled by the operating system component 155. As will be discussed below, when the operating system driver 155 fails, the server device 100 may revert to be controlled by the ROM BIOS component 160.

The example server device 100 may also include temperature sensors 130 (e.g., coupled to memory such as dual inline memory modules or DIMMs and other temperature sensitive components). The server device 100 may also include fans 135, a network interface 165 and other hardware 170 known to those skilled in the art. The network interface 165 may be coupled to a network such as an intranet, a local area network (LAN), a wireless local area network (WLAN), the Internet, etc.

The example management controller 110 may include a management processor 111, a downtime meter component 112, a server tracker module 114, one or more secondary tracker modules 116 and a real-time clock 118 that may include a battery backup. The management controller 110 may be configured to utilize the server tracker 114 and the secondary tracker(s) 116 as described below to continually monitor various server hardware and software applications and record data indicative of state changes that occur to the hardware and software to a non-volatile memory integrated into the management controller 110.

The example management controller 110 may analyze the data obtained from the server hardware and software to identify what changes have occurred and when the changes occurred, and determine an overall state of the server device 100, as described below. The management controller 110 may utilize the downtime meter component 112 along with the change data, timing data and overall server device state data to keep track of how long the server device was in each operational state as described below.

The example server 100 may include embedded firmware and hardware components in order to continually collect operational and event data in the server 100. For example, the management controller 110 may collect data regarding complex programmable logic device (CPLD) pin states, firmware corner cases reached, bus retries detected, debug port logs, etc.

The example management controller 110 may perform acquisition, logging, file management, time-stamping, and surfacing of state data of the server hardware and software application components. In order to optimize the amount of actual data stored in non-volatile memory, the management controller 110 may apply sophisticated filter, hash, tokenization, and delta functions on the data acquired prior to storing the information to the non-volatile memory.

The example management controller 110, along with the downtime meter 112, the server tracker 114 and secondary tracker(s) 116 may be used to quantify the duration and cause of server outages including both hardware and software. The management controller 110 may be afforded access to virtually all hardware and software components in the server device 100. The management controller 110 controls and monitors the health of components like the CPU 120, power supply(s) 140, fan(s) 135, memory device(s) 125, the operating system driver 155, the ROM BIOS 160, etc. As a result, the management controller 110 is in a unique position to track server device 100 availability, even when the server device 100 is not powered on due to the presence of the realtime clock/battery backup component 118.

TABLE 1

| | | DOWNTIME METERS | | | |
|---|---|---|---|---|---|
| | STATE | | UNSCHED. DOWN | SCHED. DOWN | DEGRADED |
| | TRACKERS | UP METER | METER | METER | METER |
| TRACKER | Server | OS_RUNNING | UNSCHED_DOWN | SCHED_DOWN | DEGRADED |
| STATE | Tracker | | UNSCHED_POST | SCHED_POST | |
| VALUES | DIMM | GOOD | FAILED | | |
| | Tracker | | | | |
| | Power | REDUNDANT | FAILED | | MISMATCH |
| | Supply | | | | |
| | Tracker | | | | |
| | Fan Tracker | GOOD | FAILED | | |
| | Application | RUNNING | EXCEPTION | STOPPED | DEGRADED |
| | Tracker | | | | |
| | Other | TBD | TBD | TBD | TBD |
| | Trackers | | | | |

Table 1 shows a mapping between tracker state values and downtime meter states. As shown in Table 1, the downtime meter 112, in this example, is actually a composite meter that includes four separate meters, one for each state. In this example, the four downtime meters/states include an up meter, an unscheduled down meter, a scheduled down meter and a degraded meter. The management controller 110 may receive control signals from state trackers, such as the server tracker 114 and one or more secondary trackers 116, coupled to various hardware or software components of the server and notify the downtime meter 112 of state changes such that the downtime meter 112 may accumulate timing data in order to determine how long the server device 100 has been in each state. The server tracker 114 and secondary trackers 116 may have any plural number of states (e.g., from two to “n”), where each state may be mapped to one of the up meter, unscheduled down meter, scheduled down meter or degraded meter illustrated in Table 1 above. The downtown meter 112 uses these mappings to sum up the frequency and time the server tracker 114 and/or the secondary tracker(s) 116 spend in a given state and accumulate the time in the corresponding meter.

The example management controller 110 monitors control signals received by the server tracker 114 and the secondary trackers 116, including a DIMM tracker, a power supply tracker, a fan tracker and a software application tracker, in this example. These control signals are indicative of electrical signals received from the corresponding hardware that the server tracker 114 and secondary trackers 116 are coupled to. In a nominal up and running condition, the control signals received from the trackers are indicative of the states listed in the up meter column of Table 1 (OS_RUNNING, GOOD, REDUNDANT, GOOD and RUNNING, in this example).

If any of the monitored hardware or software changes from the nominal up and running condition to another state, the corresponding tracker will provide a control signal indicative of the new state. When this occurs, the management controller 110 receives the control signal indicative of the new state and determines a new overall state for the server as well as the downtime meter state corresponding to the overall meter state. For example, if the fan tracker control signal indicates that the fan 135 has transitioned to the FAILED state, the management controller would determine the overall state of the server tracker to be UNSCHED_DOWN. The management controller 110 would then cause the downtime meter 112 to transition from the up meter to the unscheduled down meter. Upon switching meters, the downtime meter 112 can store the time of the transition from up meter to unscheduled down meter in memory and store an indication of the new state, unscheduled down.

After storing the state transition times and current states over a period of time, the downtime meter can use the stored timing/state information to calculate an availability metric. In one example, the following two equations can be used by the downtime meter 112 to calculate the unscheduled downtime, t_{unsched. down}, and the availability metric A:

$$\begin{matrix}{t}_{unsched . down} = {t}_{total} - ( {t}_{up} + {t}_{sched . down} + {t}_{degraded} ) & ( 2 ) \\ A = \frac{( {t}_{up} + {t}_{sched . down} + {t}_{degraded} )}{{t}_{total}} & ( 3 )\end{matrix}$$

The total time tₜₒₜₐₗ in equations (2) and (3) is the summation of all the meters. In this example formula, availability A in equation (3) has been redefined to account for planned power downs with the t_{sched. down} variable as well as times where the server is degraded but still functional with the t_{degraded} variable.

The example management controller 110 and the downtime meter 112 are extensible and may allow for additional secondary trackers 116 and additional overall server states. In any embodiment, the management controller 110 includes the server tracker 114. As the name suggests the server tracker 114 monitors server states. In this example, the server tracker 114 determines the overall state of the server 100 directly and controls the state of the downtime meter 112. For example, when the power button of a server is pressed on, the management controller 110 is interrupted and in turn powers the server on.

In this example, the server tracker 114 includes five states, the OS_RUNNING state when everything is nominal, the UNSCHED_DOWN and UNSCHED_POST states when the server 100 has failed and the SCHED_DOWN and SCHED_POST states when the server 100 is down for maintenance or other purposeful reason.

In this example, there are two server tracker 114 states that map to the unscheduled down meter and scheduled down meter states. The SCHED_POST and UNSCHED_POST states are intermediate states that the server tracker 114 tracks when the server 100 is booting up. Internally, the server tracker 114 is notified when the server 100 has finished the Power On Self-Test (POST) with the ROM BIOS 160, and subsequently updates from either the SCHED_DOWN to SCHED_POST or from the UNSCHED_DOWN to UNSCHED_POST states. In the same way, when the server 100 completes the POST, the management controller 110 is interrupted and notified that the operating system driver 155 has taken control of the server 100 and the server tracker 114 subsequently enters the OS_RUNNING state.

In addition to the server tracker 114 affecting the overall state of the server 100, the secondary trackers 116 also provide a role since they are a means by which the management controller may be able to determine why the server tracker 110 transitioned into the UNSCHED_DOWN state, the SCHED_DOWN state and/or the DEGRADED state. Or put another way, the secondary trackers 116 are a means by which the management controller 110 may be able to determine the cause of server 100 outages.

For example, a DIMM may experience a non-correctable failure that forces the server 100 to power down. As a result, the secondary DIMM Tracker transitions from the GOOD state to the FAILED state, and the server tracker 114 enters the UNSCHED_DOWN state. At that point, the downtime meter 112 receives an indication from the management controller 110 indicating the newly entered UNSCHED_DOWN state and the management controller 110 may store data clearly showing when the server 100 went down and further showing that the reason the server 100 went down was the DIMM failure.

As another example, if a customer inserts a 460 watt power supply 140 and a 750 watt power supply 140 into the server 100, and powers the server 100 on, then the secondary power supply tracker would communicate a control signal to the management controller 110 indicating that the power supplies 140 have entered the MISMATCH state. Since this is an invalid configuration for the server 100, the server tracker 114 would determine that the overall server state has entered the DEGRADED state and would communicate this to the downtime meter 112.

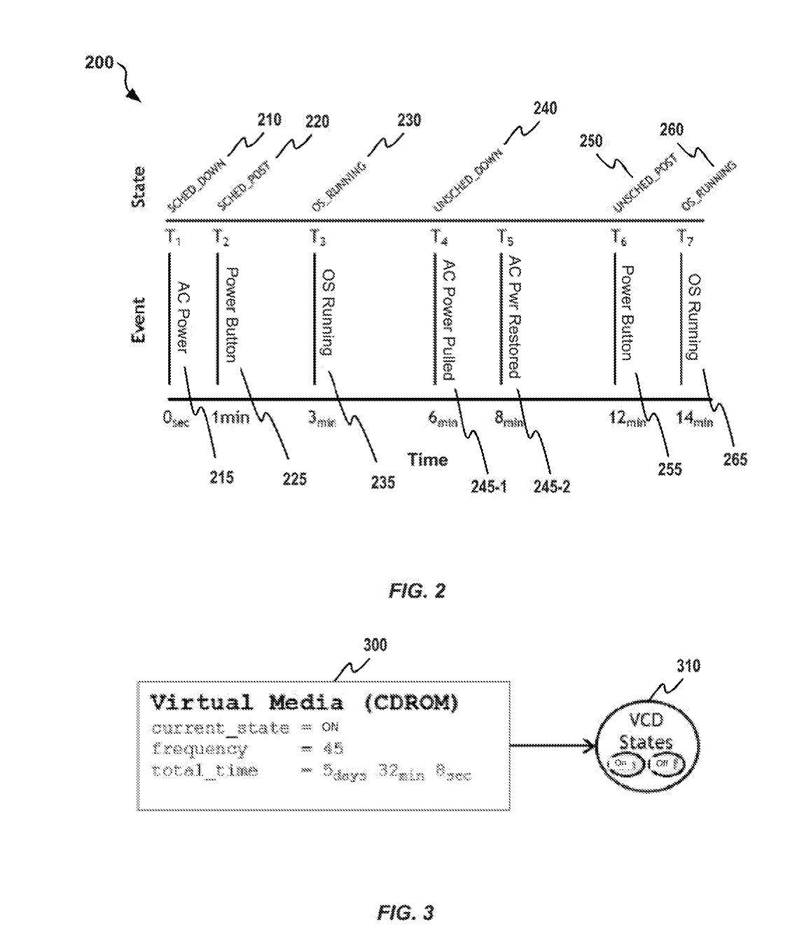

Referring to FIG. 2, an example timeline 200 shows state transitions of the example management controller 110 and downtime meter 112 in response to various events. The timeline 200 shows how the downtime meter 112 and server tracker 114 interact to produce composite meter data. At time T1, the server tracker 114 is in the SCHED_DOWN state 210 and the downtime meter 112 is using the scheduled down meter, when the server 100 experiences an AC power on event 215. At time T2, a power button is pressed (event 225) and, subsequently, the server tracker 114 enters the SCHED_POST state 220 while the downtime meter 112 continues to use the scheduled down meter.

At time T3, after the operating system driver 155 has taken control of the server 100 (event 235), the server tracker 114 transitions to the OS_RUNNING state 230 and the downtime meter 112 transitions to using the up meter. The total time recorded in the scheduled down meter equals 3 minutes, since the time spent in the SCHED_DOWN state is 1 minute and time spent in SCHED_POST state is 2 minutes. The total time recorded in the up meter is 3 minutes, since the total time spent in the OS_RUNNING state is 3 minutes. During the period from T3 to T4, the OS is running, but at time T4, the AC power is abruptly removed (event 245-1), and the server tracker 114 transitions to the UNSCHED_DOWN state 240 and the downtime meter 112 begins using the unscheduled down meter. At time T5, the AC power is restored (event 245-2), but the server tracker 114 remains in the UNSCHED_DOWN state and the downtime mater 112 continues to use the unscheduled down meter. At time T6, the power button is pressed (event 255) and, subsequently, the server tracker 114 enters the UNSCHED_POST state 250 while the downtime meter 112 continues to use the scheduled down meter. At time T7, the operating system driver 155 has taken control of the server 100 (event 265), and the server tracker 114 transitions to the OS_RUNNING state 260 and the downtime meter 112 transitions to using the up meter. During the period from T4 to T7, the total time recorded in the unscheduled down meter is 8 minutes, since the total time that the server tracker 114 spent in the UNSCHED_DOWN state is 6 minutes and the time spent in the UNSCHED_POST state is 2 minutes.

At time T4, the AC power removal shuts down both the server 100 and the management controller 110. As a result, all volatile data may be lost. This problem may be overcome by utilizing the battery of the real-time clock (RTC) 118 to power the management processor 11 prior to shutting down the management controller 110. The battery backed RTC 118 allows the management controller 110 to keep track of the time spent in the UNSCHED_DOWN state while the AC power is removed. When management controller 110 boots, the downtime meter 112 may calculate the delta between the current time and the previous time (stored in non-volatile memory). In addition, by periodically logging state transition and time information to non-volatile memory, the management controller 110 and the downtime meter 112 may maintain a complete history of all time and state data that could otherwise be lost with a loss of AC power.

The example management controller 110 and the downtime meter 112 may also support what is referred to as component trackers, as illustrated in FIG. 3. Component tracker 300 may simply monitor the ON or OFF states 310 of applications or hardware components, such as virtual media as illustrated in FIG. 3. By doing so, the management controller 110 may obtain and store useful information such as, for example, how often and how long users use a particular application or hardware component. This data may help a server supplier make decisions regarding what components are being used and how frequently. For example, if the data collected by the virtual media tracker 300 suggests the virtual media feature is used frequently by customers, then a supplier may decide to enhance and increase resources on the virtual media component. The data could also help a supplier decide whether or not to support or retire an application or component.

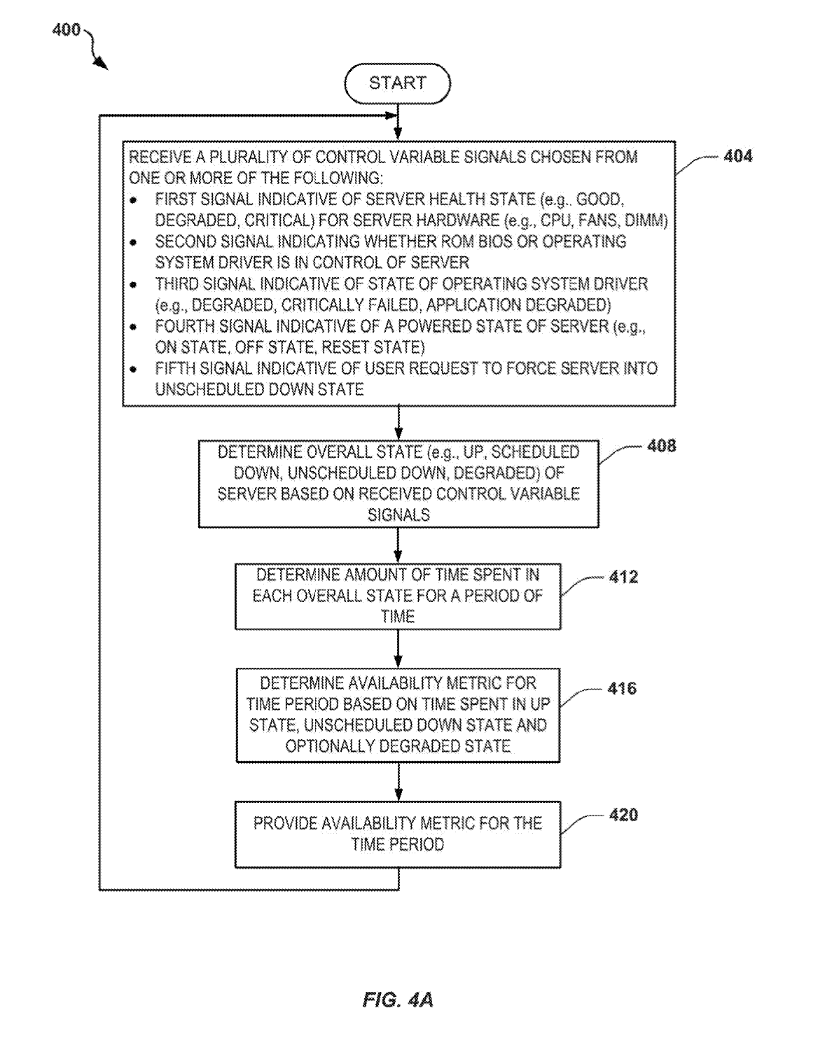

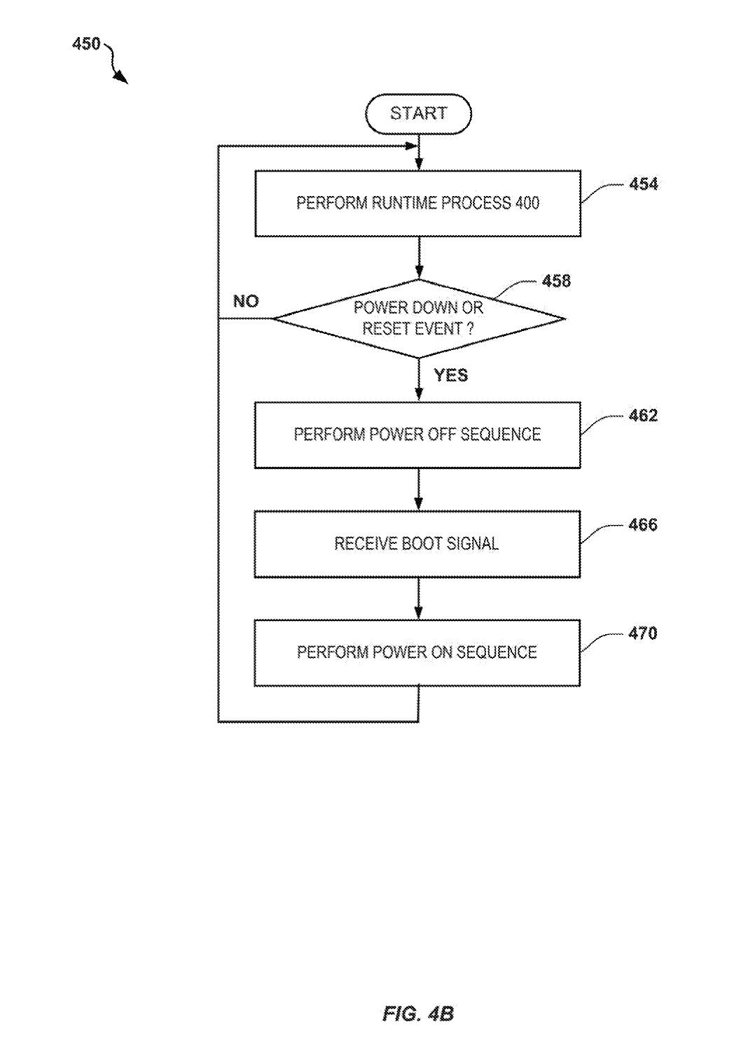

FIG. 4A illustrates an example runtime process 400 performed by a board management controller downtime meter. In various examples, the process 400 can be performed, at least in part, by the server device 100 including the management control 110 as described above with reference to FIG. 1. The process 400 will be described with further reference to FIG. 1 and Table 1.

In the example illustrated in FIG. 4A, the process 400 may begin with the management controller 110 receiving a plurality of control variable signals at block 404. The plurality of control variable signals may, for example, be indicative of at least an operating state of health of the server CPU 120 and an operating state of an operating system component such as, for example, the operating system driver 155 and the ROM BIOS 150. The control variable signals may also be indicative of states of other hardware and software in the server 100 such as, for example, the memory (e.g., DIMM) 125, temperature sensors 130, fans 135, power supplies 140, other hardware 170 and software applications 180.

The states indicated by the control variable signals received at block 404 may be similar to those states illustrated in Table 1. As described above in reference to Table 1, the server tracker 114 of the management controller 110 monitors and determines overall states of the server 100. The server tracker 114 is the principal and only tracker, in this example, that directly affects which downtime meters are used to accumulate time. The plurality of control variable signals received by the server tracker 114 may be indicative of states of all server hardware and software components.

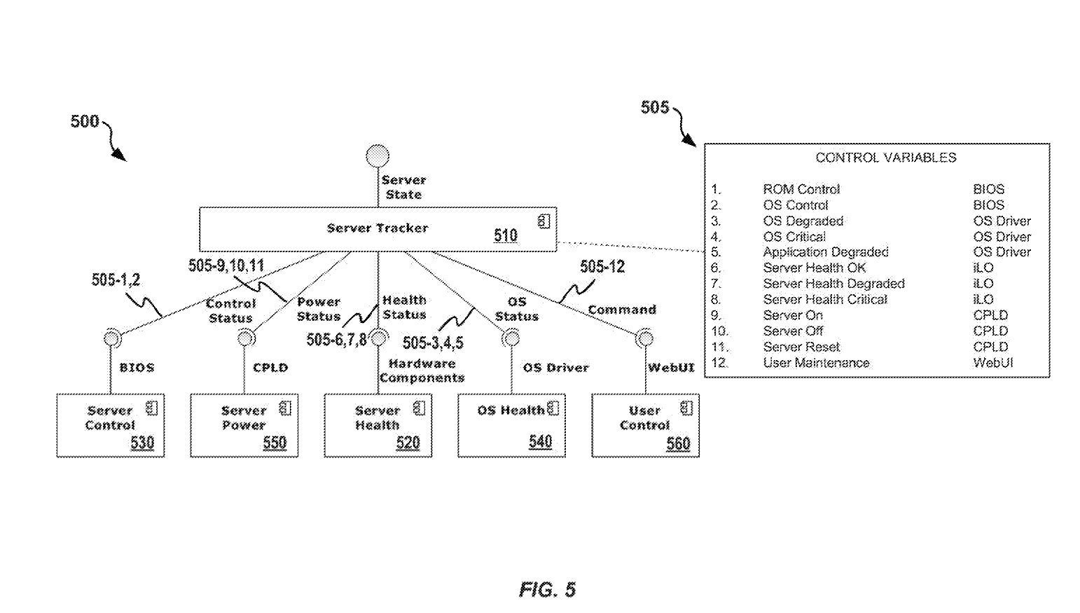

The example server tracker 114 may be configured as a server tracker 510 illustrated in FIG. 5. With further reference to FIG. 5, the server tracker 510 receives, at block 404, control variables 505 (e.g., control variables 505-1 to 505-12 shown in FIG. 5) from various server components including, in this example, a server health component 520, a sever control component 530, an operating system (OS) health component 540, a server power component 550 and a user control component 560.

The example server tracker 510 may, at block 404, receive a first control variable signal indicative of a state of health of various server hardware components (e.g., CPU 120, fans 135, memory 125, etc.) from the server health component 520. The server health component 520 may detect changes in system hardware like insertions, removals and failures to name a few. The server health component 520 may be part of the management controller 110. The server health component 520 may generate the first control variable signal to include control variable 505-6 indicative of the state of health of the server being good, control variable 505-7 indicative of the state of health of the server being degraded, and control variable 505-8 indicative of the state of health of the server being critical. For example, if the server health component 520 detects an uncorrectable memory error, then the server health component 520 may configure the first control variable signal to cause the server tracker 510 to assert control variable 505-8 indicative of the state of health of the server 100 being critical.

The example server tracker 510 may receive a second control variable signal from the server control component 530. The server control component 530 may pull information from the ROM BIOS component 160 in order to inform the server tracker 510 of whether or not the ROM BIOS component 160 or the operating system driver component 155 is physically in control of the server 100. In this example, the sever control component 530 supplies control variable 505-1 indicative of the ROM BIOS component 160 being in control, and control variable 505-2 indicative of the operating system driver component 155 being in control.

The example server tracker 510 may receive a third control variable signal from the OS health component 540. The OS health component 540 may detect operating system and application changes like blue screens, exceptions and failures, and the like. The OS Health component 540 may receive information indicative of these changes from the operating system driver component 155 and may provide control variable 505-3 indicative of the operating system driver being in a degraded state (e.g., exception), control variable 505-4 indicative of the operating system driver component 155 being in a critically failed state (e.g., blue screen and or failure) and control variable 505-5 indicative of one of the software applications 180 being in a degraded state (e.g., failed due to a software glitch). For example, if an operating system failure results in a blue screen being displayed, then the OS health component 540 will configure the third control variable signal to cause the server tracker to assert control variable 505-4 indicative of the operating system driver component 155 being in a critically failed state.

The example server tracker 510 may receive a fourth control variable signal from the server power component 550. The server power component 550 detects whether or not the server is off, on, or in a reset state. The server power component may pull power information from a complex programmable logic device (CPLD), coupled to the power supply(s) 140, and provide control variable 505-9 indicative of the server 100 being in an on state, control variable 505-10 indicative of the server 100 being in an off state (no AC power), and control variable 505-11 indicative of the server 100 being in the reset state.

The example server tracker 510 may receive a fifth control variable signal from the user control component 560. The user control component 560 may provide a command interface that may allow a user to forcibly send the server tracker 510 into the unscheduled down state (on the next server power cycle). The user control component 560 provides control variable 505-12 indicative of a user request to place the server 100 in the unscheduled down state.

The control variables 505 and the server tracker 510 illustrated in FIG. 5 are examples only. The design of the server tracker 510 is extensible and can be modified to allow for addition of as many components and reception of as many control variable signals at block 404 as needed.

In the example of FIG. 4A, at block 408, after receiving one or more of the plurality of control variable signals at block 404, the management controller 110, using, for example, the server tracker 510 of FIG. 5, determines an overall state of the server 100, and in turn determines which downtime meter to use when totaling time spent in each overall state, based on the received control variable signals. Determining the overall state of the server 100 can include the server tracker 510 determining the server 100 being in one of the 6 states illustrated in Table 1, OS_RUNNING, UNSCHED_DOWN, UNSCHED_POST, SCHED_DOWN, SCHED_POST and DEGRADED. Upon determine the server tracker state, the management controller 110 may determine which downtime meter to use. For the example shown in Table 1, the OS_RUNNING state results in an up state to be measured by the up meter, the UNSCHED_DOWN or UNSCHED_POST states result in an unscheduled down state to be measured by the unscheduled down meter, the SCHED_DOWN or SCHED_POST states result in a scheduled down state to be measured by the scheduled down meter, and the DEGRADED state results in a degraded state to be measured by the degraded meter.

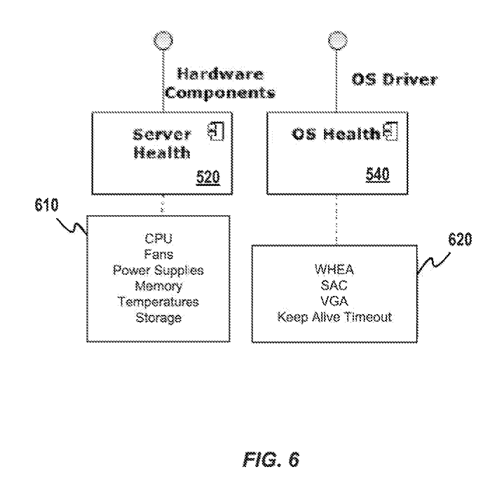

In one example, with regards to determining when the server 100 is in an unscheduled down state or a scheduled down state, there are two components (not including user control component 560) that supply control variables which may, at least in part, drive the server tracker 510 into the unscheduled down or scheduled down states. These two components are the server health component 520 and OS health component 540. FIG. 6 illustrates details of hardware and/or software monitored by the server health component 520 and the OS health component 540 to allow the server tracker 510 to assess the overall state of a server 100.

The server health component 520 may reside in the management controller 110. The server health component 520 may monitor states of individual hardware components 610, and use the information to determine whether or not the overall server 100 health is good, degraded or critical. The hardware components 610 monitored by the sever health component 520 may include the CPU(s) 120, the fan(s) 135, the power supply(s) 140, the memory 125, the temperature sensor(s) 130, and storage which may be in the other hardware component 170 of FIG. 1.

The OS health component 540 may monitor both the OS driver component 155 and software applications 180 and use the information to determine whether or not the overall operating system health is good, degraded or critical. The OS health component 540 may monitor operating system components 620 illustrated in FIG. 6. In an example server device 100, a Windows® Hardware Error Architecture (WHEA®)) provides support for hardware error reporting and recovery. In this example server 100, the WHEA supplies the OS health component 540 with information about fatal errors and exceptions like blue screens. The OS health component 540 may also monitor a Microsoft Special Administration Console® (SAC®) interface. The SAC interface, like WHEA, may be monitored for operating system errors. In addition to WHEA and SAC, the OS health component 540 may also utilize a “keep alive timeout” feature of the operating system driver component 155 to determine the state of the operating system. For example, if the operating system driver component 155 stops responding, then this may indicate a critical error at the operating system level. In addition, the OS health component 540 could snoop a VGA port of the server 100, convert the video to an image, and scan it for indications of a critical failure like a blue screen. Essentially, the OS health component 540 could look for video characteristics like texts and colors associated with critical failures like blue screens and kernel panics.

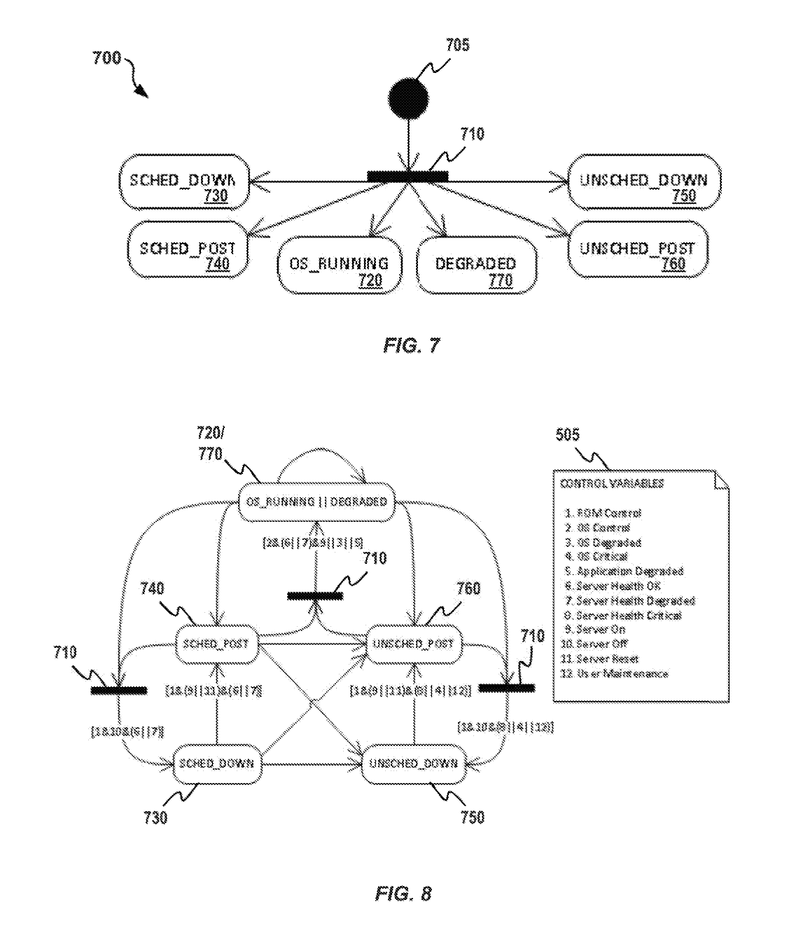

Returning to FIG. 4A, at block 408, the server tracker 510 utilizes a state machine that incorporates the control variables 505 depicted in FIG. 5. When the state machine initializes, it inspects the control variables 505 and transitions to an appropriate state. This initialization step is illustrated in FIG. 7. The server tracker is initially in an off state 705. Upon power up or reset, the server tracker 510 transitions to an initialization state 710. Depending on the which of the control variables 505 are asserted (as will be discussed below in reference to FIG. 8), the server tracker 510 transitions to one of the OS_RUNNING state 720, the SCHED_DOWN state 730, the SCHED_POST state 740, the UNSCHED_DOWN state 750, the UNSCHED_POST state 760 or the DEGRADED state 770.

After initialization, the server tracker 510 may process state transitions continuously or at least periodically. FIG. 8 depicts a post initialization runtime algorithm that may be performed by the server tracker 510 at block 408. During runtime, state transitions are triggered on changes in one or more of the control variables 505 described above. As shown in FIG. 8, the server tracker may transition from the initialization state 710 to one of the OS_RUNNING state 720, the SCHED_DOWN state 730, the UNSCHED_DOWN state 750 or the DEGRADED state 770. After a transition is complete, the server tracker 510 causes the management controller 110 to notify the down time meter 112 of the change in state of the server tracker 510 and the downtime meter 112 will respond by turning off the current downtime meter component and turning on the downtime meter component corresponding to the new server state as illustrated in Table 1 above, for example.

FIG. 8 illustrates, with control variable logic expressions between states, which control variable assertions result in transitions from one state to another server state. Table 2 summarizes some of these control variable logic expressions.

TABLE 2

| Beginning State | Ending State | Control Variables Resulting in Transition |
|---|---|---|
| Initialization 710 | OS_RUNNING 720 | [505-2 AND 505-6 AND 505-9] |
| Initialization 710 | SCHED_DOWN 730 | [505-1 AND 505-10 AND (505-6 OR 505-7)] |
| Initialization 710 | UNSCHED_DOWN 750 | [505-1 AND 505-10 AND [505-8 OR 505-4 |
| | | OR 505-12] |
| Initialization 710 | DEGRADED 770 | [505-2 AND 505-7 AND (505-3 OR 505-5)] |
| SCHED_DOWN 730 | SCHED_POST 740 | [505-1 AND (505-9 OR 505-11) AND |
| | | (505-6 OR 505-7) |
| UNSCHED_DOWN 750 | UNSCHED_POST 760 | [505-1 and (505-9 OR 505-11) AND (505-8 |
| | | OR 505-4 OR 505-12] |

In the example state transition diagram shown in FIG. 8, the DEGRADED STATE 770 and the OS_RUNNING state 720 are treated the same. This is because both the DEGRADED STATE 770 and the OS_RUNNING state 720 result in the downtime meter 112 using the up meter component as discussed above in reference to Table 1. Not all possible transitions from one state to another are labeled with logic expressions in FIG. 8, but these transitions will be obvious to those skilled in logic and state diagrams.

Returning to FIG. 4A, at block 412, upon determining the overall state of the server 100 at block 408, the management controller 110, using the downtime meter 112, determines an amount of time spent in each overall server state for a period of time. The period of time could cover several state transitions such as the example above described in reference to FIG. 2.

At block 416, the management controller 110, using the downtime meter 112, determines an availability metric for the period of time based on times spent in the up state, the unscheduled down state, the scheduled down state and, in some systems, the degraded state. The availability metric can be determined using equation (3) described above.

At block 420, the management controller 110 may provide the availability metric determined at block 416 to other computing devices. For example, the availability metric may be communicated to other server devices, management servers, central databases, etc., via the network interface 165 and the network to which the network interface 165 is coupled.

The process 400 is an example only and modification may be made. For example, blocks may be omitted, combined and/or rearranged.

Referring to FIG. 4B, an example high-level process 450 that may be performed by the management controller 110 when the runtime process 400 of FIG. 4A is interrupted by a power down or reset event is illustrated. In the example process 450, the management controller 110 may start at block 454 by performing, for example, the runtime process 400 described above and shown in FIG. 4A.

At decision block 458, the management controller 110 may continually, or periodically, monitor the power supply(s) 140 and/or the operating system driver 155 for an indication that the server 100 has lost (or is losing) power or the operating system driver 155 has failed and the server 100 will be reset. If neither of these events is detected at decision block 458, the process 450 continues back to block 454. However, if power is lost or a reset event is detected at decision block 458, the process 450 continues at block 462 where the management controller 110 performs a power off sequence.

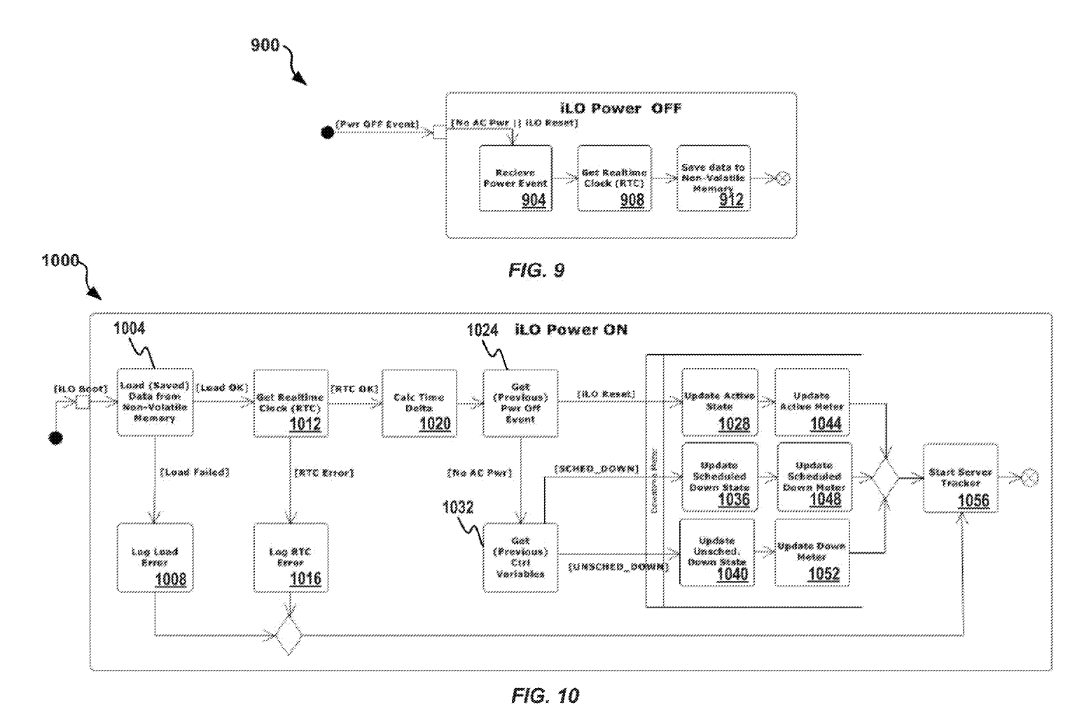

FIG. 9 illustrates an example activity diagram showing an example process 900 that may be performed by the management controller 110 during a power off or reset event at block 462. The process 900 may begin at block 904 with the management controller 110 receiving the indication of a power off or reset event. Upon receiving the power off or reset event indication, the management controller retrieves a current time from the real-time clock 118. Since the real-time clock 118 has a backup battery and the backup battery also powers the management processor 111, the loss of AC power does not affect the ability of the management controller 110 in performing the process 900. At block 912, data representing the time retrieved from the real-time clock 118 and data representing the control variables 505 asserted at the time of the power off or reset event, are stored into non-volatile memory.

Subsequent to performing the power off process 900, the management controller 110 remains powered down waiting to receive a boot signal at block 466. Upon receiving the boot signal at block 466, the process 450 may continue to block 470 and perform a power on sequence for the management controller 110. FIG. 10 illustrates an example process 1000 showing activities performed by the management controller 110 during a power on event at block 470.

At block 1004, the management controller 110 may load the data that was saved at block 912 of the power off process 900. For example, the management controller 110 may retrieve from the non-volatile memory the stored data representing the time retrieved from the real-time clock 118 upon the power off or reset event as well as the data representing the control variables 505 asserted at the time of the power off or reset event. If an error occurs in retrieving this data, the process 1000 may proceed to block 1008 where the management controller 110 may store data indicative of the error into an error log, for example.

Upon successfully loading the stored data at block 1004, the process 1000 may proceed to block 1012 where the management controller 110 may retrieve the current time from the real-time clock 118. If an error occurs in retrieving the current time, the process 1000 may proceed to block 1016 where the management controller 110 may store data indicative of the error retrieving the current time from the real-time clock 118 into the error log, for example.

Upon successfully retrieving the current time at block 1012, the process 1000 may proceed to block 1020 where the management controller 110 may retrieve data indicative of whether the event resulting in power being off was a power off event or a reset event. If the event was a reset event, the process 1000 may proceed to block 1028 where the management controller 110 may then update the server tracker 114 and the downtime meter 112 to be in the proper server state and to utilize the proper downtime meter (e.g., the up meter, the unscheduled down meter, the scheduled down meter or the degraded meter) at block 1044.

If the event resulting in power being off was a power off event, the process 1000 may proceed to block 1032 where the management controller retrieves the control variable states that were stored during the power off event at block 912 of the process 900. If the power off event occurred during a scheduled down state, the process 1000 may proceed to block 1036 to update the server tracker to the scheduled down state and then to block 1048 to update the down meter 112 to utilize the scheduled down meter. If the power off event occurred during an unscheduled down state, the process 1000 may proceed to block 1040 to update the server tracker to the unscheduled down state and then to block 1052 to update the down meter 112 to utilize the unscheduled down meter.

After updating the downtime meter 112 at one of blocks 1044, 1048 or 1052, or after logging an error at one of blocks 1008 and 1016, the process 1000 may proceed to block 1056 and the management processor 110 may restart the server tracker 114 and other components of the management controller 110.

Upon completing the power on process 1000 at block 470, the process 450 may return to block 454 where the management controller 110 may perform the runtime process 400. The process 450 is an example only and modifications may be made to the process 400. For example, blocks may be omitted, rearranged or combined.

An example of a server outage case will now be described in order to illustrate how the management controller 110 (and server tracker 510) may determine whether the downtime resulting from the server outage is scheduled or unscheduled. For example, suppose a server DIMM (e.g., part of the memory 125) fails on the first day of the month and, rather than replace the DIMM right away, a customer takes the server 100 offline until an end of month maintenance window. In this example, should the full month be counted as scheduled downtime (since the customer made this conscious decision) or unscheduled downtime (the DIMM failed but the server remained online)?

The solution to this example scenario may occur in three stages. The first stage occurs during the time interval after the DIMM fails but before the server 100 powers off. The second stage occurs after the time the server is powered off and before the next time the server 100 is powered on. The final stage occurs during the time interval after the server 100 is power on but before the operating system driver 155 starts running.

Stage 1

Initially, during stage one, the server 100 is running and there are not any issues. The server tracker 510 is in the OS_RUNNING state with control variables 505-2, 505-6 and 505-9 are asserted (i.e. equal to true). Table 1 illustrates the relationship between server tracker 510 states and downtime meters. Table 1 shows, that while the server tracker 510 is in the OS_RUNNING state, the up meter is running. Next, the DIMM fails with a correctable memory error causing control variable 505-7 to assert. This failure was correctable because an uncorrectable memory error would have caused the server to fault (blue screen) and control variable 505-1 would have been asserted rather than control variable 505-2. As a result, the server tracker transitions to the DEGRADED state since control variables 505-2, 505-7, and 505-9 are asserted. As a result, the degraded meter is running. Finally, the customer powers the server 100 down for one month. The time during this one month interval is assigned to the SCHED_DOWN server tracker state and scheduled down meter because control variables 505-1, 505-10, and 505-7 were asserted at power off. In summary, although the DIMM failed, the server 100 was still operational (i.e. degraded) and thus the choice to bring the server down was scheduled.

Stage 2

The second stage occurs after the time the server 100 is powered off and before the next time the server 100 is powered on. During this stage, the AC power was removed from the server for a month. Unfortunately, without power the management controller 110 cannot operate, but this problem is overcome by utilizing the battery backed real time clock 118. When the management controller 110 boots, the downtime meter 112 simply calculates the delta between the current time and the previous time (stored in non-volatile memory) when the management controller was powered down. FIG. 9, which was discussed above, illustrates an example server trackers power off algorithm. When the Server Tracker receives the power off event it reads the RTC and stores it to non-volatile memory.

When the management controller 110 powers on, the server tracker 510 reads the previously saved data from non-volatile memory. The data includes not only the last RTC value, but also the previous power off event as well as all the previous control variable 505 values. If the data is loaded with no issues, then the Server Tracker gets the current RTC value and calculates the time delta. The time delta represents the interval when no AC power was available. Finally, the server tracker 510 adds the time delta to the SCHED_DOWN state and the corresponding scheduled down meter, since it was the last known state indicated by the ‘previous’ control variables. The total time assigned to the SCHED_DOWN state is equal to one month plus the time accrued between the initial power off and the AC power removal.

Stage 3

The example scenario assumes that the customer replaced the faulty DIMM prior to applying AC power. In addition, at no point did the customer enter an ‘optional’ User Maintenance key via the user control component 560. Therefore after power is applied to the server and it boots, the server tracker 510 will leave the SCHED_DOWN state (instead of UNSCHED_DOWN) and enter the SCHED_POST state. Control variables 505-1, 505-9, and 505-6 are asserted and the scheduled down meter continues to run. After POST is complete, the server 100 will enter the OS_RUNNING state with control variables 505-2, 505-6 and 505-9 being asserted resulting in the up meter running.

In summary, in this particular example scenario, the replacement of the DIMM by the customer was classified as scheduled downtime since no critical health issues were encountered in the server hardware or operating system. In addition, the customer didn't utilize the user maintenance feature of the user control component 560, which would have sent the server tracker 510 into the unscheduled down state on the very next power cycle.

Various examples described herein are described in the general context of method steps or processes, which may be implemented in one example by a software program product or component, embodied in a machine-readable medium, including executable instructions, such as program code, executed by entities in networked environments. Generally, program modules may include routines, programs, objects, components, data structures, etc. which may be designed to perform particular tasks or implement particular abstract data types. Executable instructions, associated data structures, and program modules represent examples of program code for executing steps of the methods disclosed herein. The particular sequence of such executable instructions or associated data structures represents examples of corresponding acts for implementing the functions described in such steps or processes.

Software implementations of various examples can be accomplished with standard programming techniques with rule-based logic and other logic to accomplish various database searching steps or processes, correlation steps or processes, comparison steps or processes and decision steps or processes.

The foregoing description of various examples has been presented for purposes of illustration and description. The foregoing description is not intended to be exhaustive or limiting to the examples disclosed, and modifications and variations are possible in light of the above teachings or may be acquired from practice of various examples. The examples discussed herein were chosen and described in order to explain the principles and the nature of various examples of the present disclosure and its practical application to enable one skilled in the art to utilize the present disclosure in various examples and with various modifications as are suited to the particular use contemplated. The features of the examples described herein may be combined in all possible combinations of methods, apparatus, modules, systems, and computer program products.

What is claimed is:

1. A server, comprising:
a server tracker to:
receive at least one first control variable signal indicative of an operating state of health of the server, the at least one first control variable signal indicating the operating state of health as one of a good state, a degraded state, or a critical state; and
receive at least one second control variable signal indicative of a state of an operating system, the state of the operating system being one of under operating system driver control, under pre-boot component control, or critically failed;
the server tracker determining an overall state of the server based on the first and second control variable signals, the overall state being one of an up state, a degraded state, a scheduled down state, or an unscheduled down state; and
a downtime meter to track an amount of time spent in at least the up state, the scheduled down state and the unscheduled down state.

2. The server of claim 1, wherein the server tracker determines the overall state is a scheduled down state when the first control signal indicates a state other than the good state and the second control signal indicates the state of the operating system as under operating system driver control.

3. The server of claim 1, wherein the server tracker determines the overall state is an unscheduled down state when the first control signal indicates a state other than the good state and the second control signal indicates the state of the operating system as under pre-boot component control.

4. The server of claim 1, wherein the downtime meter further tracks an amount of time spent in the degraded state.

5. The server of claim 1, wherein:
the overall state is determined to be the up state when the first control variable signal indicates the health of the server is in the good state, and the second control variable signal indicates the state as under operating system driver control,
the overall state is determined to be the degraded state when the first control variable signal indicates the health of the server is in the degraded state, and the second control variable signal indicates the state as under operating system driver control,
the overall state is determined to be the scheduled down state when the first control variable signal indicates the health of the server is in the good state or the degraded state, and the second control variable signal indicates the state as under pre-boot component control, and
the overall state is determined to be the unscheduled down state when the second control variable signal indicates the state as under pre-boot component control and either the first control variable signal indicates one or more of the following:
the second control variable signal further indicates the state of the operating system as critically failed state, or
the first control variable signal indicates the health of the server is in the critical state.

6. The server of claim 1, wherein the downtime meter determines an availability metric for a period of time, wherein the availability metric represents the amount of time spent in two or more of the up state, the degraded state and the scheduled down state over the period of time.

7. The server of claim 1, wherein server tracker further receives at least one third control variable signal indicative of a powered state of the server device, the powered state being one of an on state, an off state or a reset state, wherein the server tracker determining the overall state to be in:
the up state when the third control variable signal is indicative of the on state,
the scheduled down state when the third control variable is indicative of the off state, and
the unscheduled down state when the fourth control variable is indicative of the off state.

8. The server of claim 1, further comprising:
a real-time clock powered by a backup battery,
wherein the downtime meter determines the amount of time spent in each of the schedule down state and the unscheduled down state based in part on a time received from the real-time clock.

9. The server of claim 1, further comprising:
a component tracker to monitor at least one of an on state and an off state of at least one software application or hardware component and to store information indicative of usage time or frequency of a software application or hardware component.

10. A method, comprising:
receiving a plurality of control variable signals indicative of at least an operating state of health of a processor of a device and an operating state of an operating system component of the device, the operating state of health of the processor being one of a good state, a degraded state or a critical state, the operating state of the operating system component being one of under control of an operating system driver, under control of a pre-boot component, or a critically failed state;
determining an overall state of the device based on the received plurality of control variable signals, the overall state being one of an up state, a degraded state, a scheduled down state and an unscheduled down state; and
tracking an amount of time spent in at least the up state, the scheduled down state and the unscheduled down state.

11. The method of claim 10, wherein:
the overall state is determined to be the up state when the received plurality of control variable signals indicates the health of the server is in the good state and the state of the operating system as under operating system driver control,
the overall state is determined to be the degraded state when the received plurality of control variable signals indicates the health of the server is in the degraded state and the state of the operating system as under operating system driver control,
the overall state is determined to be the scheduled down state when the received plurality of control variable signals indicates the health of the server is in the good state or the degraded state and the state of the operating system as under pre-boot component control, and
the overall state is determined to be the unscheduled down state when the received plurality of control variable signals indicates the state of the operating system as under pre-boot component control and either:
the state of the operating system further as critically failed state, or
the state of the health of the server is in the critical state.

12. The method of claim 10, further comprising:
monitoring at least one of an on state and an off state of at least one software application or hardware component and to store information indicative of usage time or frequency of a software application or hardware component.

13. An apparatus, comprising:
a processor, and
a memory device including computer program code, the memory device and the computer program code, with the processor, to cause the apparatus to:
receive a plurality of control variable signals indicative of at least an operating state of health of a processor of a device and an operating state of an operating system component of the device, the operating state of health of the processor being one of a good state, a degraded state or a critical state, the operating state of the operating system component being one of under control of an operating system driver, under control of a pre-boot component, or a critically failed state;
determine an overall state of the device based on the received plurality of control variable signals, the overall state being one of an up state, a degraded state, a scheduled down state and an unscheduled down state; and
track an amount of time spent in at least the up state, the scheduled down state and the unscheduled down state.

14. The apparatus of claim 13, wherein:
the overall state is determined to be the up state when the received plurality of control variable signals indicates the health of the server is in the good state and the state of the operating system as under operating system driver control,
the overall state is determined to be the degraded state when the received plurality of control variable signals indicates the health of the server is in the degraded state and the state of the operating system as under operating system driver control,
the overall state is determined to be the scheduled down state when the received plurality of control variable signals indicates the health of the server is in the good state or the degraded state and the state of the operating system as under pre-boot component control, and
the overall state is determined to be the unscheduled down state when the received plurality of control variable signals indicates the state of the operating system as under pre-boot component control and either:
the state of the operating system further as critically failed state, or
the state of the health of the server is in the critical state.

15. The apparatus of claim 13, wherein the memory device and the computer program code, with the processor, further cause the apparatus to:
monitor at least one of an on state and an off state of at least one software application or hardware component and to store information indicative of usage time or frequency of a software application or hardware component.
